(19) United States
(12) Patent Application Publication
(10) Pub. No.: US 2017/0066677 A1
(43) Pub. Date: Mar. 9, 2017

(54) METHOD OF MAKING SHAPED GLASS ARTICLES

(71) Applicant: Corning Incorporated, Corning, NY (US)

(72) Inventors: Dana Craig Bookbinder, Corning, NY (US); Thierry Luc Alain Dannoux, Avon (FR); Pushkar Tandon, Painted Post, NY (US); Natesan Venkataraman, Painted Post, NY (US)

(21) Appl. No.: 15/243,037

(22) Filed: Aug. 22, 2016

Related U.S. Application Data
(60) Provisional application No. 62/214,335, filed on Sep. 4, 2015.

(51) Int. Cl. C03B 23/00; C03B 23/03

(52) U.S. Cl. CPC C03B 23/0086; C03B 23/03; C03C 21/002

(57) ABSTRACT

A method of making a shaped laminated glass article, including:
a first heating to a first temperature of at least a first area of a laminated glass sheet having a core and at least one clad layer on the core, the first heating is above the softening point of the first area;
a second heating to a second temperature of at least a second area of the laminated glass sheet, the second heating is above the softening point of the second area; and
deforming at least a portion of the second softened area of the laminated glass sheet to form the shaped laminated glass article,
wherein the first temperature is different from the second temperature, the first area is greater than the second area, and the first area encompasses the second area.

Also disclosed is shaped laminated glass article that can be made by the disclosed method.

This application claims the benefit of priority under 35 U.S.C. §119 of U.S. Provisional Application Ser. No. 62/214,335 filed on Sep. 4, 2015 the content of which is relied upon and incorporated herein by reference in its entirety.

### CROSS-REFERENCE TO RELATED APPLICATION

This application is related to commonly owned and assigned patent documents, but does not claim priority thereto:

U.S. Ser. No. 61/989,712 filed May 4, 2014, entitled “Shaped Glass Articles and Methods for Forming the Same,” which mentions a method of making including contacting a glass sheet with a forming surface to form a shaped glass article;

U.S. Ser. No. 61/952,580 filed Mar. 3, 2014, entitled “Glass Article and Method for Forming the Same,” which mentions a method including contacting a glass laminate having a core and a clad adjacent to the core with a reagent to degrade the clad at a rate greater than the core;

U.S. Ser. No. 61/989,704 filed May 7, 2014, entitled “Laminated Glass Article and Method for Forming the Same,” which mentions a glass laminate article comprising: a core layer; and cladding layer, wherein the CTE of the core is greater than an average CTE of the cladding layer, and an effective 109.9 P temperature of the glass article is at most about 750° C.; and

U.S. Pat. No. 9,061,934, to Bisson, filed Oct. 8, 2012, entitled “Apparatus and Method for Tight Bending Thin Glass Sheets.”

The entire disclosure of each publication or patent document mentioned herein is incorporated by reference.

### BACKGROUND

The disclosure relates to a formed or shaped laminated glass product.

### SUMMARY

In embodiments, the disclosure provides a formed or shaped laminated glass article, and a method of making the formed or shaped laminated glass article.

### BRIEF DESCRIPTION OF THE DRAWINGS

In embodiments of the disclosure:

FIG. 1 shows a strengthened laminate glass (100) starting material.

FIGS. 2A to 2C show a schematic of representative stress profiles seen in various types of strengthened glasses.

FIG. 3 is a schematic that shows the use of a single or first heated or hot, for example, from 650 to 1050° C., glass laminate sheet (100) having a uniform core and clad thickness in forming an article having a base and side walls of dissimilar thicknesses.

FIG. 4 shows a variation of the method of making illustrated in FIG. 3 having a base and side walls of similar thicknesses.

FIG. 5 shows a schematic view of successive pre-shaping and forming operations performed on a flat glass laminate ribbon (500), directed towards preparing a desired glass thickness distribution on a ribbon for even thickness repartition of the final product (550).

FIG. 6 shows a schematic view of the disclosed method of how to transform a uniformly flat laminate sheet (610) starting material or non-flat laminate sheet (not shown) starting material into a shaped laminate article (620).

FIGS. 7A and 7B, respectively, show a perspective drawing (7A) of an exemplary necked container article (700) having multiple deep bend shapes prepared from a single glass laminate sheet (100), and the exemplary necked container article (700) in partial cross-section view (7B).

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### DEFINITIONS

“Softening point” of a glass composition or like terms refer to the temperature at which the viscosity of the glass composition is about 10^{7.6} Poise (P).

“Hollow ware” or like terms refer to, for example, glass containers, such as flasks, bottles, vials, dispensers, and like articles.

“Draw” or like terms refer to the displacement from planarity of a laminate sheet when the laminate sheet is selectively heated to a molten or flowable formable temperature, and contacted with a displacement force.

“Deep draw” or like terms, such as “shaped” and “formed”, refer to the extent of displacement from planarity, for example, from 65 to 100 degrees.

“Sheet” or like terms refer to a substantially flat piece, plate, pane, or like descriptors, of laminate glass having a length and a width dimension. The sheet can have a constitution that is, for example: rigid, inflexible, flexible, resiliently bendable, rollable, or like stable or metastable shapes, at ambient temperatures.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

U.S. Pat. No. 4,381,932 mentions a laminated glass gob used for pressing glass articles.

U.S. Pat. No. 4,457,771 mentions forming laminated articles from a composite encapsulated charge of molten glass.

U.S. Pat. No. 4,735,855 mentions a thermo-formable polymeric laminate.

The disclosure is related to a method of making a strengthened laminated glass article that includes forming a shaped strengthened laminated glass article, i.e., an object other than a flat strengthened laminated glass sheet.

In embodiments, the disclosed method is applicable to making, for example: an intermediate glass laminate article, such as a preform, parison, or blank; and a final shaped glass laminate article via the intermediate glass laminate article.

In embodiments, the disclosed method is applicable to making a shaped final glass laminate article directly from a flat laminate glass sheet.

In embodiments, the disclosed method can use, for example, impact extrusion, or like methods, to form an intermediate parison.

In embodiments, the disclosed method can use, for example, blow molding, or like methods, to form a final glass laminate article directly from the heated glass laminate sheet or from an intermediate glass laminate parison.

In embodiments, the disclosed method can use, for example, a blowing rod that can function firstly as a plunger, for example, in impact extrusion for creating a glass laminate preform and secondly as an blow molding inflator (e.g., gas conduit) for creating a glass laminate blown article, for example, with or without a mold form.

In embodiments, the disclosed method can be used in combination with other known molding methods, such as compression molding, injection molding, precision glass molding, impact extrusion, and like methods, for glass laminate perform production, for glass laminate preform modification, for glass laminate article formation,

In embodiments, the disclosed method can convert a flat laminate glass sheet having uniform thickness into a shaped laminate glass article including hollow ware or deep bend ware, for example, a shaped bowl, a shaped vial, and like other deep bend shapes, where the resulting deep bend shape can have a uniform wall thickness, such as in a dish or a vial, or variable wall thickness, such as in a vial or a bottle. In embodiments, the final wall thickness of the article can be less than or equal to the starting thickness of the flat laminate glass sheet. In embodiments, the thickness of the core and clad layers in the final laminate glass article can be less than or equal to thicknesses of the core and clad layers of the starting flat laminate glass sheet. In embodiments, the relative thickness proportion or thickness ratio of the core and clad layers in the final laminate glass article can be can be the same (i.e., ratio retained) thickness ratio or a different (i.e., ratio changed) thickness ratio compared to the starting flat laminate glass sheet depending, for example, on the deforming methods employed such as one or more of rod plunging and mold stretching.

In embodiments, the disclosed method selectively controls the viscosity of the flat laminate glass sheet in the different regions (R₁ and R₂) by selectively heating and softening different regions of the flat laminate glass sheet. In embodiments, the disclosed method controls the thickness of the flat laminate glass sheet by pre-selecting the thickness of the flat laminate glass sheet and the relative thicknesses of the core and the clad layers of the flat laminate glass sheet, i.e., the pre-emboss or pre-molding thickness profile of the flat laminate glass sheet. In embodiments, the selectively heated flat laminate glass sheet can be selectively stretched in the heated areas to yield an intermediate or final product. In embodiments, the final product can be self-strengthened because of a deliberate coefficient of thermal expansion (CTE) mismatch between the core and clad layers of the starting flat laminate glass sheet. This self-strengthening can be retained throughout the article formation and article finishing. In embodiments, the resulting intermediate glass laminate article or the resulting final glass laminate article can be further strengthened by, for example, an ion-exchange method.

In embodiments, the disclosure provides a formed or shaped strengthened laminated glass article, and a method of making the formed or shaped strengthened laminated glass article.

In embodiments, the disclosure provides a formed laminated glass product, and formed laminated glass products having a strengthened laminated glass sheet as a feedstock.

In embodiments, the disclosure provides a method for forming strengthened laminated glass products, for example, in a large scale production and in rapid processing times.

In embodiments, the disclosure provides a method using a strengthened laminated glass sheet feedstock and a process of selectively heating portions of the strengthened laminated glass sheet feedstock to different temperatures for the article forming method and for achieving strength and other desirable attributes, such as chemical durability and good surface quality.

In embodiments, the disclosure provides a formed strengthened laminated glass article, and a method of making the formed strengthened laminated glass article.

In embodiments, the disclosure provides a method of forming shaped laminated glass articles in a large production scale using a strengthened laminated glass sheet feedstock to create such shapes as vials and other deep bend geometries.

In embodiments, the disclosure provides a strengthened glass laminate product and other advantages, such as chemical durability and formability by selecting a viscosity ratio (η₂/η₁) of the inner glass (“core”) layer and outer glass (“clad”) layer or layers.

In embodiments, the strengthened glass sheet feedstock can be comprised of a laminated structure. In embodiments, the strengthened glass sheet feedstock can be comprised of, for example, a laminated structure having three layers including a single core layer and two clad layers. In embodiments, the strengthened glass laminate sheet feedstock can be comprised of a laminated structure having five or more layers such as a single core layer and four, like or dissimilar, clad layers. In embodiments, the strengthened glass laminate sheet feedstock can be made by, for example, conventional lamination methods and then conventional ion-exchange processes. In embodiments, the strengthened glass laminate sheet feedstock can have a surface compressive stress of more than 100 MPa. In embodiments, the strengthened glass laminate sheet feedstock has a surface compressive stress of more than 300 MPa. In embodiments, the strengthened glass laminate sheet feedstock can have a surface compressive stress of more than 600 MPa.

In embodiments, the overall thickness of the strengthened glass laminate sheet feedstock can be from 0.01 to 10 mm, including intermediate values and ranges, for example, less than 10 mm, such as 0.01 to 10 mm, less than 5 mm, such as 0.01 to 5 mm, less than 1 mm, such as 0.01 to mm, and less than 0.1 mm, such as 0.01 to 0.1 mm.

In embodiments, the disclosure provides a shaped glass laminate article having a sidewall of thickness δ_{2f} and a base of thickness δ_{1f}, wherein the sidewall angle, Θ, relative to the base is larger than 65°, and the core:clad thickness ratio follows 0.7≦δ_{2f}/δ_{1f}≦1.3. In embodiments, the core:clad thickness ratio of δ_{2f}/δ_{1f} can be, for example, from 0.9 and 1.1. In embodiments, the forming angle in the deep drawn strengthened article has a forming angle ≧70° such as 70 to 100°. In embodiments, the side wall angle (Θ), or alternatively named the forming angle, in the deep drawn strengthened article can be, for example, greater than or equal to 80° such as 80 to 100°. In embodiments, the disclosure provides a strengthened glass laminate sheet that has a thickness that is 5% greater in some regions of the sheet compared to the other regions of the strengthened glass sheet such that when the unformed strengthen glass sheet is formed into a shaped glass laminate article, the thickness of the sidewalls are similar to the base thickness in the final shaped glass laminate article.

In embodiments, the disclosure provides a method of forming a strengthened glass laminate sheet into a shaped glass laminate article that involves the heating of the strengthened glass laminate sheet, wherein the heating step comprises differential heating of certain portions of the heating region compared to other portions of the heating region such that when the unformed strengthen glass laminate sheet is deformed into a shaped glass laminate article, the thickness of the sidewalls are similar to the base thickness in the final shaped glass laminate article.

The present disclosure is advantaged is several aspects, including for example:

The method of making can be used to prepare formed shapes having a laminate or composite structure that can be further strengthened.

The shapes can be formed at a sufficiently low forming temperature such that no special equipment is needed other than the typical soda-lime forming equipment.

The disclosed shaped glass article can have considerable acid durability similar to available soda lime glass products, which permits the use of the shaped glass article in applications such as auto glazing, or large external displays.

The strengthened glass laminate sheet feedstock enables a mass production method that can be used to make deep bend shapes such as vials, and other containers, that can have a glass having excellent chemical durability on the outside while having a soft core that allows for a fast forming method and for a lower temperature forming method.

The resulting laminate article can also have strength after forming without having additional strengthening method steps such as tempering or ion-exchange.

The disclosed method can use an appropriately designed laminate feedstock having appropriate thickness variations such that the appropriate use of heating and cooling rates can create articles having appropriate final wall thickness, for example, a vial having a uniform wall thickness and optionally uniformly proportionate core and clad thicknesses.

In embodiments, the disclosure provides a method of making a shaped laminated glass article, i.e., the product, comprising:

a first heating to a first temperature of at least a first area of a laminated glass sheet having a core and at least one clad layer on the core, i.e., the starting material, the first heating is above the softening point of the first area;

a second heating to a second temperature of at least a second area of the laminated glass sheet, the second heating is above the softening point of the second area; and

deforming at least a portion of the second softened area of the laminated glass sheet to form the shaped laminated glass article, wherein the first temperature is different from the second temperature, the first area is greater than the second area, and the first area encompasses the second area.

In embodiments, the second area does not necessarily have to be coextensive with the first area, the second area is preferably not coextensive with the first area, and the first area and the second area may or may not share the same center point or concentricity.

In embodiments, the first heating can be, for example, from 500 to 1000° C., the second heating can be, for example, from 600 to 1000° C., and the first heating and second heating can be accomplished, for example, simultaneously, contemporaneously, sequentially, serially, or a combination thereof, and the ratio (R₂:R₁) of the viscosity in the second heated area (R₂) to the viscosity in the first heated area (R₁) can be, for example, greater than or equal to 1.3, such as 1.3 to 2, 1.4 to 1.8, 1.5 to 1.7, including intermediate values and ranges.

In embodiments, the first heating can be accomplished from the same side or the opposite side as the second heating side.

In embodiments, the glass clad layer can be present, for example, on both sides of the core.

In embodiments, the disclosed method can further comprise strengthening by, for example, ion-exchange of: the laminated glass sheet prior to deforming, the shaped laminated glass article after deforming, or both.

In embodiments, the deforming of at least a portion of the second softened area of the laminated glass sheet can include, for example, achieving at least one sidewall bend angle (Θ) greater than or equal to 60°.

In embodiments, the laminated glass sheet can have a surface compressive stress of from 100 to 1000 MPa, such as 100, 200, 300, 400, 500, 600, 700, 800, 900, 1000 MPa, including intermediate values and ranges.

In embodiments, the deforming at least a portion of the second softened area of the laminated glass sheet can include contacting at least one of the softened areas with at least one of: a motive force, such as a piston, a plunger, an awl, a vacuum, and like forces, a mold and like forms, or a combination thereof.

In embodiments, the shaped laminated glass article can have at least one deep bend shape having at least one sidewall bend angle (Θ) of greater than or equal to 65°.

In embodiments, the exterior surface of the shaped laminated glass article, i.e., the product, retains at least one property of the laminated glass sheet, i.e., the starting material, prior to heating, the property being selected from, for example, surface quality, strength, chemical durability, or a combination thereof.

In embodiments, the laminated glass sheet, prior to heating, can be sourced from, for example, at least one of: a fusion draw apparatus, a double fusion draw apparatus, an ion-exchange reactor, or a combination thereof.

In embodiments, the laminated glass sheet can be, for example, a discrete piece of glass, or a continuous ribbon of glass.

In embodiments, the disclosed method can further comprise, for example, in mass production or scale up situations, at least one of:

continuously supplying and continuously selectively heating at least a portion of the laminated glass sheet or roll above its softening point;

continuously deforming at least a portion of the selectively heated portion of the laminated glass sheet or roll;

continuously separating the resulting deformed portions of the laminated glass sheet or roll from the un-deformed portions or waste portions of the sheet or roll, or a combination thereof.

In embodiments, the disclosure provides a laminated glass article made by the method disclosed above.

In embodiments, the laminated glass article can be, for example, selected from: a bottle, a vial, a beaker, an enclosure, a non-planar display glass, a bowl, a glass storage container, and like shapes and containers, or combinations thereof.

In embodiments, the disclosure provides a laminated shaped glass article comprising:

a sidewall of thickness δ_{2f};

a base of thickness δ_{1f};

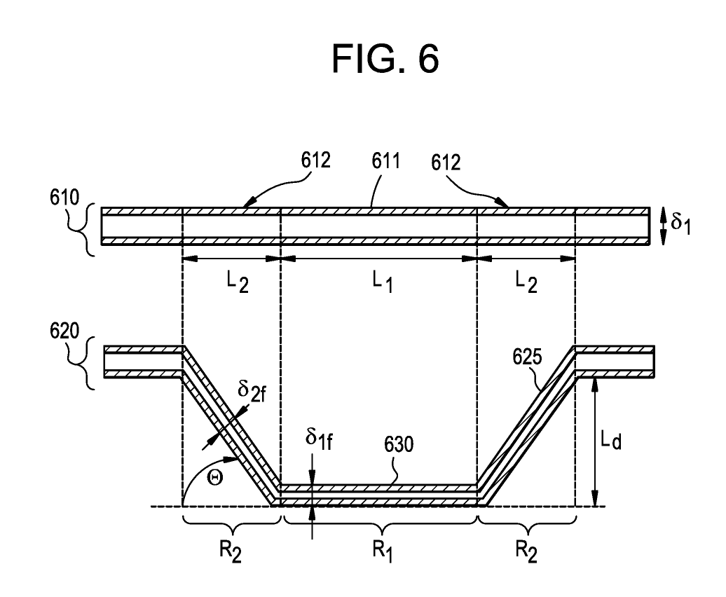

a sidewall bend angle (see FIG. 6), Θ, between the plane of the base and the exterior of the sidewall of greater than 65°;

a deformation depth L_{d} greater than 10 mm, i.e., L_{d}≧10 mm; and

the ratio of δ_{2f} to δ_{1f} is 0.7≦δ_{2f}/δ_{1f}≦1.3.

In embodiments, the ratio of δ_{2f}/δ_{1f} can be, for example, from 0.9 to 1.1.

In embodiments, the base of thickness δ_{1f} can be, for example, 0.1≦δ_{1f}≦2 mm, and the deformation depth L_{d} can be, for example, 10 mm≦L_{d}≦100 mm.

In embodiments, the glass article can further comprise, for example, a minimum diameter L_{dia-min} of greater than or equal to 10 mm, i.e., L_{dia-min}≧10 mm such as from 10 to 100 mm, and from 10 to 1000 mm, including intermediate values and ranges.

In embodiments, the shaped glass article, i.e., the product, can be, for example, at least one ion-exchanged laminate glass.

In embodiments, the surfaces of the sidewalls and base have a surface compressive stress of from 100 to 1000 MPa, such as 100, 200, 300, 400, 500, 600, 700, 800, 900, 1000 MPa, including intermediate values and ranges.

In embodiments, the surfaces of the sidewalls and the base of the article can have a compressive stress layer depth (i.e., “depth of layer”) of, for example, from 10 to 1000 microns, including intermediate values and ranges.

In embodiments, the disclosed article can be a vessel selected, for example, from at least one of: a container, a vial, a dish, a bowl, e.g., a common open-top container, a bottle for containing a fluid, a pitcher, a contoured window in a vehicle, a contoured structural component in a vehicle such as fender, a body panel, a boat hull, or a combination thereof.

In embodiments, the disclosure provides a method of making a shaped glass laminate article, including, for example:

heating at least a portion of a strengthened glass sheet to a first temperature above its softening point, e.g., to a temperature of 650 to 1050° C. to render the sheet deformable; and

deforming at least a portion of the heated portion of the strengthened glass sheet, for example, by applying at least one force suitable to deform the sheet into a shape or form other than a sheet.

In embodiments, the deforming at least a portion of the heated portion of the strengthened glass sheet comprises or consists of, for example, contacting the strengthened glass sheet that includes the heated portion with at least one of: a motive force, a mold, or a combination thereof.

In embodiments, the heating and deforming can be accomplished simultaneously or sequentially.

In embodiments, the strengthened glass sheet can have, for example, a laminated structure and can have, for example, a core layer and at least one clad layer on each face or surface of the core.

In embodiments, the strengthened glass sheet can have, for example, a laminated structure and can have, for example, a core layer and a clad layer on each surface or face of the core layer.

In embodiments, the shaped glass article can have at least one deep bend shape wherein the sidewall angle, Θ, relative to the base is greater than 65°, for example, containers generally, such as vials, bottles, flasks, medical enclosures such as a syringe, dishware such as bowls, and like glass articles.

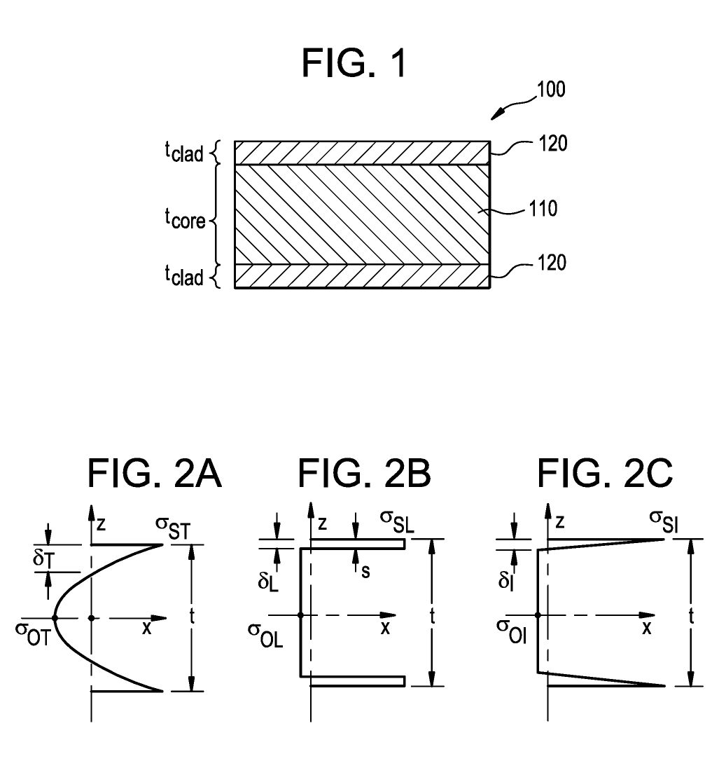

Referring to the figures, FIG. 1 is a schematic of a laminated glass sheet having a structure (100). The core glass composition (110) can be selected to have higher CTE as compared to the clad glass (120) composition. A careful selection of the glass composition provides compressive stress in the clad (skin) and the tensile stress in the core during the cooling process. Here the core and clad thickness ratio (TR) is defined as TR=t_{core}/2t_{clad}, where t_{core} is the core thickness, and t_{clad} is the clad thickness.

The core glass composition can be selected to have a mismatched CTE condition, i.e., a higher CTE, for example, from 40 to 100×10⁻⁷/° C., compared to the CTE of the clad glass composition, for example, from 20 to 60×10⁻⁷/° C. Judicious selection of the glass compositions can provides compressive stress in the clad (skin) and the tensile stress in the core during the cooling process.

FIG. 2 shows a schematic of the stress profiles seen in various types of strengthened glasses including tempering (a), lamination (b), and ion-exchange (c). In the present disclosure a combination of the lamination profile and the ion-exchange profile are selected and achieved.

If one selects a lower CTE clad (outer) glass and a higher CTE core (inner) glass one can establish a permanent residual stress such that there is compression in the outer glass and this leads to a strengthened glass laminate product.

Additionally, the disclosed method provides flexibility to select a chemically durable clad having a high softening point, for example, greater than 800° C., while having a lesser durable core or inner glass having, for example, a softening point of 650° C. If the skin is thinner than the core one can generally form this composite at a temperature lower than the softening point of the clad glass alone and thereby access a formability window.

Preliminary experiments achieved multiple formed deep bend shapes from a laminate feedstock (photographic images not shown). The formed shapes were prepared using a torch to heat and soften a portion of the glass laminate surface, then a piston or plunger, such as a carbon rod, was contacted with the heated and softened glass laminate surface to controllably deform the glass laminate. The deformed glass laminate surface showed remarkably low levels of surface marking.

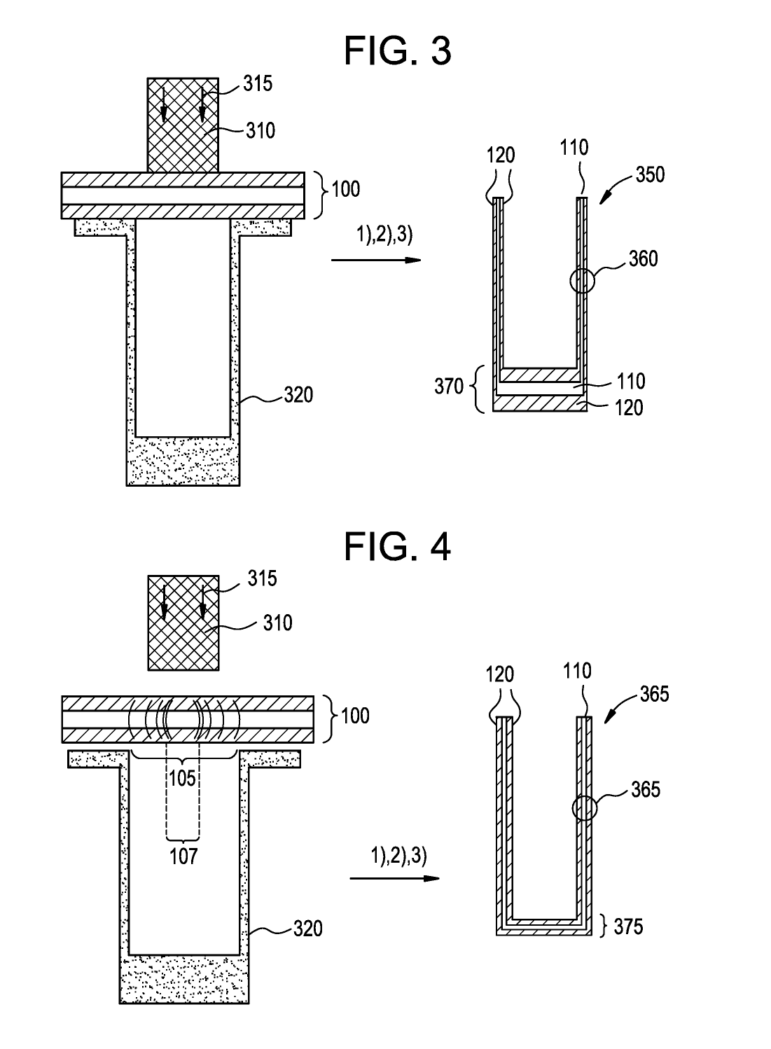

FIG. 3 is a schematic that shows the use of a single or first heated or hot, for example, from 650 to 1050° C., glass laminate sheet (100) having a uniform thickness in forming an article. In embodiments, the method of making can produce a shaped part (350) having a uniform thickness in selected regions but not all regions have the same thickness in the final formed product. The laminate sheet having an appropriately selected thickness, for example, from 0.5 to 2.0 mm, is formed into a mold (320) by, for example, a motive force (315), such as a plunger (310), a vacuum (not shown), or blow mold. After forming and separation (e.g., removal) of the shaped article from the mold, the method yields an article having with different regions having different thicknesses, for example, the walls (360) have the same or similar thickness and the base (370) has a different thickness, such as a thicker base compared to the walls. In a first step 1) the first heated glass laminate is placed over a mold. In a second step 2) a deforming motive force, such as a plunger, a vacuum, an air blow or gas pressure source, or combination thereof, is applied to the first heated glass laminate region to mold the laminate. In a third step 3) the deformed/molded article is separated from the mold and optionally trimmed. The separated article has side walls that are significantly thinner than the base or bottom of the separated article.

FIG. 4 shows a variation of the method of making illustrated in FIG. 3 where the glass laminate (100) is first heated (105) and then second heated (107) (i.e., differential heating with a satisfactory heat source, for example, a flame or a laser, which provides a heated laminate having a core (110) or center that has greater glass flow compared to the clad (120) portions of a laminate), which after forming in accord with the present disclosure yields a final formed product (450) having walls that have a similar side wall (365) thickness as the base (375) of the product. In a first step 1) the first heated and second heated glass laminate, the “profiled” hot laminate is placed over a mold. In a second step 2) a deforming motive force, such as a plunger, a vacuum, an air blow or gas pressure source, or combination thereof, is applied to the first heated and second heated glass laminate region to mold the laminate. In a third step 3) the deformed/molded article is separated from the mold and optionally trimmed. The separated article has side walls (365) that have substantially the same thickness as the base or bottom portion (375) of the separated article.

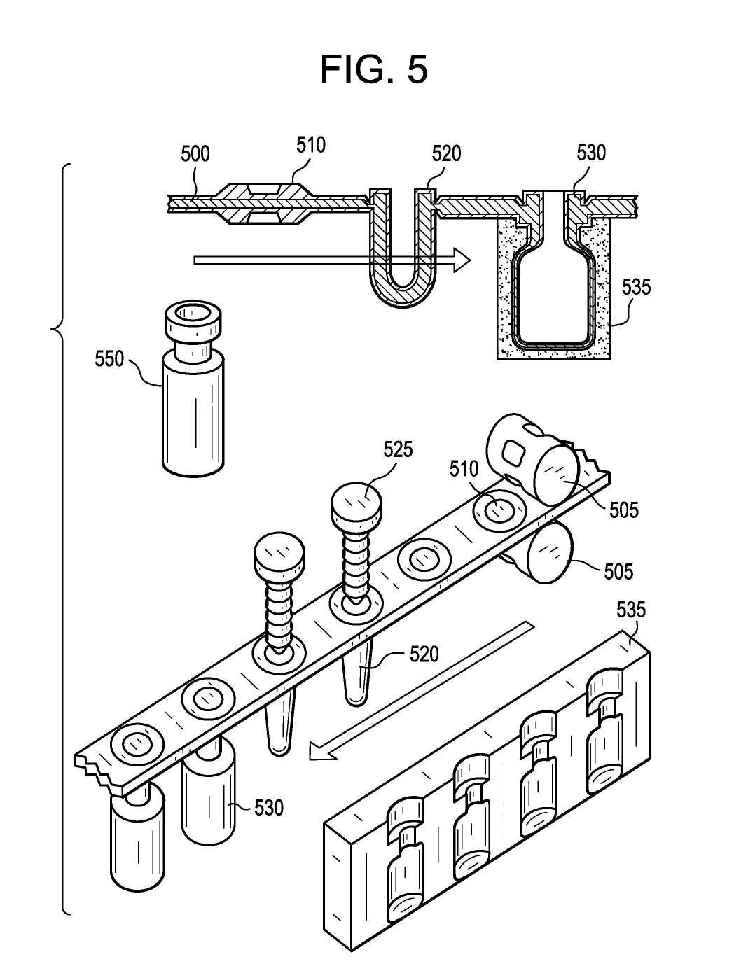

FIG. 5 shows a schematic view of successive pre-shaping and forming operations performed on a flat glass laminated ribbon (500), directed towards preparing a desired glass thickness distribution on a ribbon for even thickness repartition of the final product (550). In embodiments, the flat glass laminate ribbon (500) can firstly be pressed or rolled (505) to provide a first laminate profile (510). The first laminate profile (510) can secondly be punched or pressed, for example, with an appropriately sized and shaped awl (525) into a pre-shaped laminate ribbon (520). The pre-shaped laminate ribbon (520) or blank, can thirdly be blown (530) against an open-able mold (535), individually or in series, then separated to afford the article (550).

FIG. 6 shows a schematic view of the disclosed method of how to transform a uniformly flat laminate sheet (610) or non-flat laminate sheet (not shown) into a shaped laminate article (620) having, for example, a bowl shape, a vial shape, or another deep shape having a relatively uniform thickness, and where the thickness of the final deep shaped article is less than or equal to the thickness of the starting uniform flat laminate sheet (610). The method can include controlling the viscosity of the glass in the different heated regions (611) (also referred to as Region 1 (R₁) and having a length L₁) and (612) (also referred to as Region 2 (R₂) and having a length L₂) of the laminate sheet (610), pre-selecting the thickness in the regions (611 and 612), or a combination thereof, i.e., a viscosity-thickness control scheme. The initial glass sheet (610) thickness is δ_{L} the sidewall thickness (625) is δ_{2f}, and a base thickness (630) is δ_{1f}. The sidewall angle, Θ, is relative to the base, and L_{d} is the depth of deformation of the final shaped glass article. In embodiments, a viscosity-thickness control scheme can be, for example, to emboss a thickness profile on the uniform flat laminate glass sheet, which embossed sheet is then stretched (i.e., shaped) to yield the final deep shaped product. The final product can exhibit increased strength properties due to the lamination properties (e.g., CTE mismatch). This strength can be retained throughout the steps of the disclosed method, i.e., the first and second profiled heating and deforming.

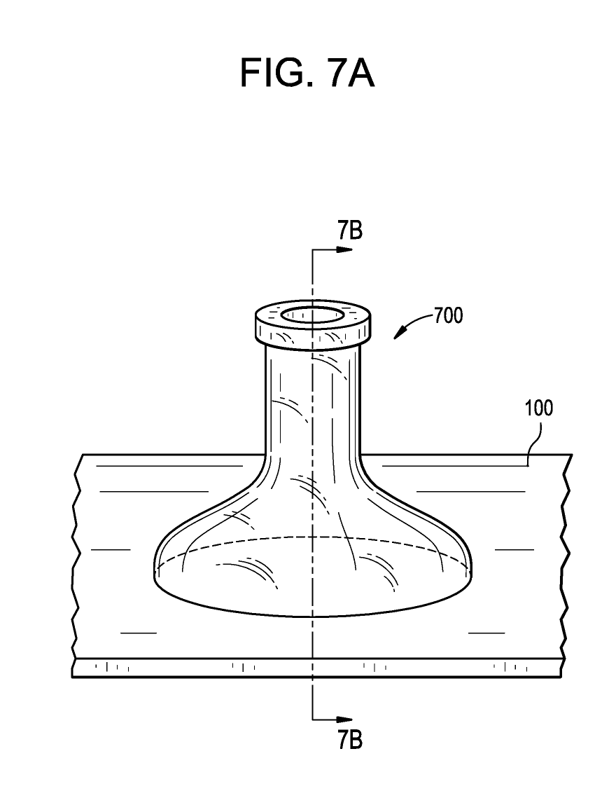

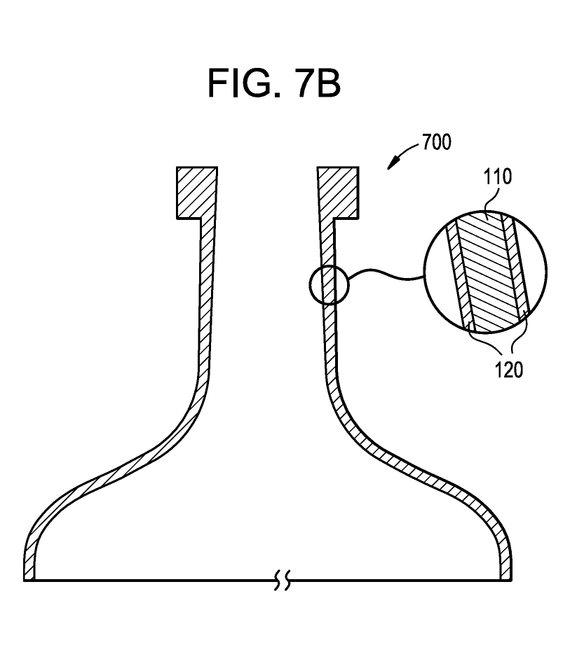

FIGS. 7A and 7B, respectively, show a perspective drawing (7A) of an exemplary necked container article (700) having multiple deep bend shapes prepared from, for example, a single glass laminated sheet (100) or laminated roll stock, and the exemplary necked container article (700) in partial cross-section view (7B). The necked container articles (700) were prepared by selectively heating the laminate sheet (100) with a torch as shown in FIG. 4, and then deforming the selectively heated laminate sheet by plunging with a shaped carbon rod. Examination of the formed surface revealed unexpectedly and exceptionally low incidence of surface tool marking. The inset in FIG. 7B shows proportionately uniform core and clad laminate layer (110 and 120) thicknesses at different locations in the wall of the shaped or deep bend laminate article.

### EXAMPLES

The following examples demonstrate making, use, and analysis of the disclosed formed glass laminate articles and methods in accordance with the above general procedures.

### Example 1

A deep bend shape, formed, or shaped glass laminate sample was prepared by heating, using a hydrogen-oxygen torch, a square glass laminate sheet, e.g., about 102 mm (4 inches) wide per side, and 0.7 mm (0.027 inches) thick. The sheet was first heated at a low temperature broad flame of approximately 4 cm in diameter, at from about 800 to 900° C. until the sheet just started to sag. Next the center or core of the sheet was heated to from about 900 to 1000° C. with a narrowly focused flame or light beam, having about a 10 mm diameter, and then the doubly heated laminate sheet was contacting with a 5 mm diameter plunger, e.g., plunging a carbon rod into the glass laminate sample at a right or normal angle (e.g., 90°) and removing the carbon rod, to provide the deep bend shape. No mold was used in this carbon rod plunge experiment. The resulting formed laminate glass article had a depth of about 34 mm, an angle Θ (capital theta) between the bottom and the sidewall of about 80 to 85°, and sidewall thicknesses and bottom wall thicknesses of about 0.1 mm.

The glass laminate sheet was made by a known laminate fusion draw process having a clad layer of about 50 microns on each side of the glass core, and having a glass laminate sheet total thickness of 0.7 mm. The glass laminate sheet was made with a clad was substantially alkali-free and having a CTE of about 30×10⁻⁷/° C., and a softening point of about 985° C. The glass laminate was comprised of the core glass having a CTE of about 85×10⁻⁷/° C., and softening point of about 837° C. The deep bend shapes prepared by this example retained a significantly shiny exterior and showed minimal tool marking (e.g., mold marks). The minimal tool marking has been observed in other forming processes, such as 3D forming, or mold pressing. The resulting glass laminate deep bend shape had an core thickness of about 0.9 mm and both clad layers had a thickness of about 0.05 mm for a total glass laminate thickness of about 1.0 mm.

### Modeled Examples

The following examples were modeled. Referring to FIG. 6, a flat glass laminate sheet of initial thickness, δᵢ, of 0.1 cm is formed into a deep shape strengthened glass article having a draw angle of greater than or equal to 65° (Θ≧65°). L₁ and L₂ are the lengths (in cross-section) in the initial glass sheet corresponding to the final base and sidewall lengths of the formed article. Cos Θ refers to the cosine of Θ. For working viscosities η₁ and η₂ in regions 1 (R₁) and region 2 (R₂), respectively, the final thicknesses of the sidewall δ_{2f} and base δ_{1f}, respectively, in the formed glass laminate article is calculated using the following equations (Eq. 1 to 3):

X=η₂ cos Θ/η₁ (1)

δ_{2f}=δᵢ(L₂+XL₁)/((L₂/cos Θ)+XL₁) (2)

δ_{1f}=δᵢ−X(δᵢ−δ_{2f}) (3)

The final thicknesses of the sidewall δ_{2f} and base δ_{1f}, are calculated for different combinations of L₁ and L₂, Θ, and η₁ and η₂ in regions 1 (R₁) and region 2 (R₂). The modeled examples use the viscosity curves of the core glass of the glass laminate sheet, that is, the clad layer was about 50 microns thick on each side of the glass core, and the core had a softening point of about 837° C. and having thickness of 900 microns, and the clad glass had a softening point of about 985° C. The final thickness ratio of δ_{2f}/δ_{1f} is calculated to be between about 0.7 and 1.3 in the inventive examples listed in Table 1. This is in contrast to the comparative examples shown in Table 2 where the ratio δ_{2f}/δ_{1f} is less than 0.7 for draw angles of Θ≧65°.

TABLE 1
Modeled Inventive examples.

| | Initial Sheet | Length of | Length of | Viscosity of | Viscosity of | Viscosity |
|---|---|---|---|---|---|---|
| | Thickness, | Region 1, | Region 2, | Region 1 | Region 2 | Ratio Region |
| Inventive | δᵢ, | L₁ | L₂, | (η₁), | (η₂), | 2:Region 1 |
| Example | (cm) | (cm) | (cm) | (10⁷ Poise) | (10⁸ Poise) | (η₂/η₂) |
| 2 | 0.1 | 10 | 5 | 8.00 | 1.00 | 1.3 |
| 3 | 0.1 | 10 | 5 | 7.50 | 1.00 | 1.3 |
| 4 | 0.1 | 10 | 5 | 3.50 | 1.00 | 2.9 |
| 5 | 0.1 | 10 | 5 | 3.50 | 1.00 | 2.9 |
| 6 | 0.1 | 10 | 5 | 3.00 | 1.00 | 3.3 |
| 7 | 0.1 | 10 | 5 | 2.50 | 1.00 | 4.0 |
| 8 | 0.1 | 10 | 5 | 2.20 | 1.00 | 4.5 |
| 9 | 0.1 | 10 | 5 | 2.08 | 1.00 | 4.8 |
| 10 | 0.1 | 10 | 5 | 1.74 | 1.00 | 5.7 |
| 11 | 0.1 | 10 | 5 | 1.58 | 1.00 | 6.3 |
| 12 | 0.1 | 10 | 2 | 6.41 | 1.00 | 1.6 |
| 13 | 0.1 | 10 | 2 | 5.71 | 1.00 | 1.8 |
| 14 | 0.1 | 10 | 2 | 2.00 | 1.00 | 5.0 |
| 15 | 0.1 | 10 | 2 | 1.70 | 1.00 | 5.9 |
| 16 | 0.1 | 10 | 2 | 1.55 | 1.00 | 6.5 |
| 17 | 0.1 | 10 | 2 | 3.85 | 1.00 | 2.6 |

| | | Final Thickness | Final Thickness | | Ratio of final |
|---|---|---|---|---|---|
| | Theta | of Sheet (δ_{2f}) | of Sheet (δ_{1f}) | Final | thickness of |
| Inventive | (Θ), | in Region 2 | in Region 1 | depth, L_{d}, | sheet in |
| Example | degrees | (cm) | (cm) | (cm) | δ_{2f}/δ_{1f} |
| 2 | 65 | 0.053 | 0.075 | 10.7 | 0.70 |
| 3 | 65 | 0.053 | 0.074 | 10.7 | 0.72 |
| 4 | 65 | 0.062 | 0.054 | 10.7 | 1.15 |
| 5 | 75 | 0.038 | 0.054 | 18.7 | 0.70 |
| 6 | 75 | 0.039 | 0.048 | 18.7 | 0.83 |
| 7 | 75 | 0.042 | 0.039 | 18.7 | 1.05 |
| 8 | 75 | 0.043 | 0.033 | 18.7 | 1.30 |
| 9 | 80 | 0.028 | 0.040 | 28.4 | 0.70 |
| 10 | 80 | 0.030 | 0.030 | 28.4 | 1.00 |
| 11 | 80 | 0.031 | 0.024 | 28.4 | 1.29 |
| 12 | 70 | 0.055 | 0.076 | 5.5 | 0.72 |
| 13 | 70 | 0.056 | 0.074 | 5.5 | 0.76 |
| 14 | 80 | 0.040 | 0.048 | 11.3 | 0.83 |
| 15 | 80 | 0.043 | 0.042 | 11.3 | 1.03 |
| 16 | 80 | 0.044 | 0.038 | 11.3 | 1.18 |
| 17 | 80 | 0.031 | 0.069 | 11.3 | 0.45 |

### Comparative Example 1

Example 1 was repeated with the exception that after heating the glass sheet uniformly over an area of about 4 cm in diameter where it began to sag, there was no narrowly focused flame applied to the center of the glass sheet. Then the heated laminate sheet was contacted with a 5 mm diameter plunger, e.g., plunging a carbon rod into the glass laminate sample at a right angle (e.g., 90°) and removing the carbon rod, to provide the deep bend shape. No mold was used in this carbon plunge rod experiment. The resulting formed laminate glass article had a depth of about 38 mm, an angle between the bottom and the sidewall of about 80 to 85°, the sidewall thickness of about 0.08 to 0.1 mm and bottom wall thickness of about 0.6 mm. The thickness ratio of the sidewall/bottom (δ_{2f}/δ_{1f}) was from about 0.1 to about 0.2.

TABLE 2
Comparative Examples.

| | Initial | Length of | Length of | Viscosity | Viscosity | Viscosity | |
|---|---|---|---|---|---|---|---|
| | Thickness of | Region 1, | Region 2, | (η₁) of | (η₂) of | Ratio Region | Theta |
| Comp. | the Sheet, δᵢ, | L₁ | L₂ | Region 1, | Region 2, | 2:Region 1 | (Θ), |
| Example | (cm) | (cm) | (cm) | (10⁷ Poise) | (10⁸ Poise) | (η₂/η₂) | degrees |
| 1 | 0.1 | 10 | 5 | 1.00 | 1.00 | 1.0 | 65 |
| 2 | 0.1 | 10 | 5 | 1.00 | 1.00 | 1.0 | 75 |
| 3 | 0.1 | 10 | 5 | 1.00 | 1.00 | 1.0 | 80 |
| 4 | 0.1 | 10 | 2 | 1.00 | 1.00 | 1.0 | 70 |
| 5 | 0.1 | 10 | 2 | 1.00 | 1.00 | 1.0 | 80 |

| | Final Sheet | Final Sheet | | |
|---|---|---|---|---|
| | Thickness (δ_{2f}) | Thickness (δ_{1f}) | Final | Sheet final |
| Comp. | in Region 2, | in Region 1, | depth, L_{d}, | thickness ratio |
| Example | (cm) | (cm) | (cm) | (δ_{2f}/δ_{1f}) |
| 2 | 0.051 | 0.079 | 10.7 | 0.64 |
| 3 | 0.031 | 0.082 | 18.7 | 0.37 |
| 4 | 0.020 | 0.086 | 28.4 | 0.23 |
| 5 | 0.049 | 0.083 | 5.5 | 0.59 |
| 6 | 0.023 | 0.087 | 11.3 | 0.27 |

Although not wanting to be limited by theory it is believed that the lack of tool marking artifacts may be attributable to the clad layers having a higher viscosity at the forming temperature than the core, and the clad can be free of alkali.

This example demonstrates that one can form a shaped glass laminate article having deep bend shapes by plunging with a suitable motive force and using the strengthened or un-strengthened feedstock.

In embodiments, the disclosed method can be scaled to, for example, use a larger laminate sheet to make a larger formed article, or for mass production.

The laminate sheets do not have to be made by a laminate fusion process but can be obtained from other processes such as slot draw, and like other similar processes.

In embodiments, the disclosed method can use a controlled differential heating means, for example, a flame, a laser, and like means, or a combination thereof, and a plunger to create the deep bend shapes in, for example, making individual pieces (FIG. 6) or in mass production (FIG. 5). The final strength of the formed glass laminate will depend on the CTE differential between the core and clad layers. The final formed glass laminate product is expected to retain much of the strength of the initial unformed glass laminate. In embodiments, the strength of the final formed glass laminate product can be higher than the strength of the initial unformed glass laminate by having the formed glass laminate product cool at a fast rate during the forming method (i.e., after the deforming step).

In embodiments, in the disclosed method one can select a viscosity difference between core and clad layer(s) to predict the forming temperature. One can minimize the volatilization or loss (if any) of the clad glass layer, or other deleterious effects of the interaction between the clad glass and a plunger, or other surfaces the clad glass layer may encounter.

In embodiments, the disclosed method offers a unique method that enables the mass production of deep bend shapes having significant strength and other attributes, such as chemical durability.

In embodiments, the disclosed method provides considerable flexibility to select the laminate feedstock starting material (see FIG. 4) to yield a formed article having side wall thickness that is similar to the thickness of the bottom or base of the formed article. If one selects a uniformly thick laminate feedstock, i.e., the overall thickness of the laminate used as a feedstock is uniform from one location to another location, then the laminate is deep shaped to provide a final shaped article that also has nearly uniform overall thickness from one location to another location. In embodiments, the disclosed method can use a deep mold (see e.g., FIG. 3) to create a final product that will have side wall thicknesses different from the thickness of the base if the formed glass is uniformly heated and uniformly cooled, i.e., the base is thicker than the side walls.

The laminate feedstock can be made by any suitable lamination process, for example:

fusing three sheets together (two clad layers and one core) in a fusion draw process, in a process where the three sheets are stacked and then fused, or in a process where the sheets are co-drawn using a slot draw process; or

bonding the three sheets together (two clad layers and one core) in a direct bonding process that bonds the glass layers at a lower temperature than the softening point.

The laminated or bonded feedstock (i.e., a strengthened glass sheet) is then used in the disclosed method to form a deep bend shape.

In embodiments, the strengthened glass sheet can be made using an ion exchange method.

In embodiments, the glass core can have a composition comprised of an alkali species. In embodiments, the glass core can comprise in weight percent, on an oxide basis, for example: i) 50≦SiO₂≦65%; ii) 10≦Al₂O₃≦20%; iii) 0≦MgO≦5%; iv) 10≦Na₂O≦20%; v) 0≦K₂O≦5%, and in embodiments vi) ≧0 of at least one of B₂O₃, CaO, ZrO₂, and Fe₂O₃. In embodiments, the glass can be an alkali glass including, for example, P₂O₅, which promotes a more efficient ion-exchange of the glass. These composition and exemplary wt % ranges are summarized in Table 3.

TABLE 3
Alkali-containing glasses.

| Component (wt %) | min | max |
|---|---|---|
| SiO₂ | 40 | 80 |
| RO (MgO, CaO, SrO, BaO, ZnO) | 0 | 25 |
| Al₂O₃ | 0 | 20 |
| P₂O₅ | 0 | 15 |
| B₂O₃ | 0 | 30 |
| R₂O (Li, Na, K, Rb) | 4 | 25 |

The deep bend shaping process can carefully heat the laminate feedstock using, for example, a burner or a series of burners, or like or equivalent heat sources, to permit the fine manipulation of the glass and its movement, and also the use of a plunger or plungers to create the desired shapes. The plungers, molds, or both, can be made of, for example, any suitable material such as carbon, steel, Inconel, and like materials, or combinations thereof.

The two glass compositions of the respective clad layer and core layers in the laminate feedstock can be selected so that:

the clad layer has a lower CTE (e.g., 30 to 40° C.) compared to the core layer, has high chemical durability, and has a softening at from 700 to 1050° C.;

the core has a higher CTE (e.g., 50 to 90° C.) compared to the clad layer, not necessarily a high chemical durability, and has softening at from 650 to 800° C.; and

the clad layer thickness can be, for example, from 10 to 200 microns and the total thickness of the feedstock can be, for example, from 0.4 mm to 2.0 mm.

In embodiments, the thickness of the unformed laminate feedstock sheet can be, for example, less than 10 mm. In embodiments, the thickness of the unformed laminate feedstock sheet can be, for example, less than 5 mm. In embodiments, the thickness of the unformed laminate feedstock sheet can be, for example, less than 1 mm.

In embodiments, the strengthened unformed feedstock sheet is a laminated structure. In embodiments, the strengthened unformed feedstock sheet has a laminate structure comprising three layers. In embodiments, the strengthened unformed feedstock sheet has a laminate structure comprising five or more layers.

In embodiments, the strengthened unformed laminate glass sheet feedstock is strengthened using an ion-exchange process.

The disclosure has been described with reference to various specific embodiments and techniques. However, it should be understood that many variations and modifications are possible while remaining within the scope of the disclosure.

What is claimed is:

1. A method of making a shaped laminated glass article, comprising:
a first heating to a first temperature of at least a first area of a laminated glass sheet having a core and at least one clad layer on the core, the first heating is above the softening point of the first area;
a second heating to a second temperature of at least a second area of the laminated glass sheet, the second heating is above the softening point of the second area; and
deforming at least a portion of the second softened area of the laminated glass sheet to form the shaped laminated glass article,
wherein the first temperature is different from the second temperature, the first area is greater than the second area, and the first area encompasses the second area.

2. The method of claim 1 wherein the first heating is from 500 to 1000° C., the second heating is from 600 to 1000° C., and the first heating and second heating are accomplished simultaneously, contemporaneously, sequentially, serially, or a combination thereof, and the ratio of the viscosity in the second heated area to the viscosity in the first heated area is greater than or equal to 1.3.

3. The method of claim 1 wherein the glass clad layer is present on both sides of the core.

4. The method of claim 1 further comprising strengthening by ion-exchange: the laminated glass sheet prior to deforming, the shaped laminated glass article after deforming, or both.

5. The method of claim 1 wherein deforming at least a portion of the second softened area of the laminated glass sheet comprises achieving at least one bend angle (Θ) greater than or equal to 60°.

6. The method of claim 1 wherein the shaped laminated glass article has at least one deep bend shape having at least one bend angle (Θ) of greater than or equal to 65°.

7. The method of claim 1 wherein the laminated glass sheet has a surface compressive stress of from 100 to 1000 MPa.

8. The method of claim 1 wherein deforming at least a portion of the second softened area of the laminated glass sheet comprises contacting at least one of the second softened areas with at least one of: a motive force, a mold, or a combination thereof.

9. The method of claim 1 wherein the exterior surface of the shaped laminated glass article retains at least one property of the laminated glass sheet prior to heating, the property being selected from surface quality, strength, chemical durability, or a combination thereof.

10. The method of claim 1 wherein the laminated glass sheet, prior to heating, is sourced from at least one of: a fusion draw apparatus, a double fusion draw apparatus, an ion-exchange reactor, or a combination thereof.

11. The method of claim 1 wherein the laminated glass sheet is a discrete piece of glass, or a continuous ribbon of glass.

12. The method of claim 1 further comprising at least one of:
continuously supplying and continuously selectively heating at least a portion of the laminated glass sheet above its softening point;
continuously deforming at least a portion of the selectively heated portion of the laminated glass sheet;
continuously separating the resulting deformed portions of the laminated glass sheet from the sheet, or
a combination thereof.

13. A laminated glass article made by the method of claim 1.

14. The laminated glass article of claim 13 wherein the glass article is selected from: a bottle, a vial, a beaker, an enclosure, a non-planar display, a bowl, or a storage container.

15. A laminated shaped glass article comprising:
a sidewall of thickness δ_{2f},
a base of thickness δ_{1f};
a sidewall angle, Θ, between the plane of the base and the exterior of the sidewall of greater than 65°;
a deformation depth L_{d} greater than 10 mm; and
the thickness ratio of δ_{2f} to δ_{1f} is 0.7≦δ_{2f}/δ_{1f}≦1.3.

16. The glass article of claim 15, wherein the thickness ratio of δ_{2f}/δ_{1f} is from 0.9 to 1.1.

17. The glass article of claim 15 wherein 0.1≦δ_{1f}≦2 mm, and 10 mm≦L_{d}≦100 mm.

18. The glass article of claim 15 further comprising a minimum diameter L_{dia-min} greater than 10 mm.

19. The glass article of claim 15, wherein the shaped glass article comprises at least one ion-exchanged laminate glass.

20. The glass article of claim 15, wherein the surfaces of the sidewalls and base have a surface compressive stress of from 100 to 1,000 MPa.

21. The glass article of claim 20, wherein the surfaces of the sidewalls and the base have a compressive stress layer depth of from 10 to 1,000 microns.
